(19) United States
(12) Patent Application Publication
(10) Pub. No.: US 2025/0078251 A1
(43) Pub. Date: Mar. 6, 2025

(54) OBSERVATION AND/OR INSPECTION OF A MATERIAL WEB

(71) Applicant: Texmag GmbH Vertriebsgesellschaft, Thalwil (CH)

(72) Inventor: Tobias Nennstiel, Stadtbergen (DE)

(21) Appl. No.: 18/825,624

(22) Filed: Sep. 5, 2024

(30) Foreign Application Priority Data
Sep. 6, 2023 (DE) 10 2023 123 992.9

(51) Int. Cl. G06T 7/00; G06F 15/17

(52) U.S. Cl. CPC G06T 7/001; G06F 15/17; G06T 2207/30108

(57) ABSTRACT

The present disclosure relates to a device for observing and/or inspecting a material web, comprising a first camera unit for capturing first image data of the material web; a first computing unit, connected to the first camera unit, adapted to receive the first image data; and a second computing unit adapted to receive the first image data from the first computing unit. The first and the second computing units are connected via a first USB line. The first image data is transferred to the second computing unit via the first USB line. A first USB interface of the first computing unit and a second USB interface of the second computing unit are connected via the first USB line. Another aspect of the present disclosure relates to a device for processing a material web, comprising the material web and the device for observing and/or inspecting the material web.

### RELATED APPLICATIONS

This application claims a right of priority under 35 U.S.C. § 119 (a) to German application DE 10 2023 123 992.9, filed on Sep. 9, 2023.

### TECHNICAL FIELD

The disclosed subject matter relates to a device for observing and/or inspecting a material web and to a device for processing a material web comprising a material web and the device for observing and/or inspecting the material web. In particular, the disclosed subject matter relates to image data transmission during observation and/or inspection of the material web.

### BACKGROUND

Material webs and devices for processing them are used, for example, in the paper and film industry (e.g., in print shops). A material web, e.g., made of paper, plastic, and/or metal, is often moved in the longitudinal direction via a motorized roller system of the device. Movements transverse to the longitudinal direction can, for example, be controlled via so-called rotating frame systems within the device. In coordination with the movement in the longitudinal direction, the material web can be processed with a high degree of automation. Processing can include, for example, printing, cutting, and/or sorting. The increasing speeds of the material webs in the longitudinal direction, e.g., with speeds of up to 1300 m/min, advantageously increase the throughput, but at the same time place high demands on the devices for processing a material web and on devices for observing and/or inspecting the material web.

Devices for observing and/or inspecting the material web can be used when processing material webs, for example to ensure that the automated processing fulfills specified quality criteria at all times. In addition to automated monitoring, visual monitoring by a process supervisor (operator) can also be supported. In this type of quality assurance, the material web is guided under observation and/or inspection systems that record images of the material webs. These images can then be checked by a process supervisor (operator) or automatically. For example, a device for observation and/or inspection can be used to check whether different printing colors are applied to the material web without (perceptible) offset or whether there are general defects in the print or damage to the material, etc. USB lines that are specified according to the USB 3.0 standard or higher are known in the state of the art. Ethernet can be used via a USB interface using the g_ether driver from the Linux-USB Gadget API Framework.

### SUMMARY

Production processes in print shops are becoming ever faster and more precise. The quality of the print results is constantly increasing and waste must be reduced to a minimum.

A device for observation and/or inspection often comprises at least one first camera unit that captures first image data of the material web. With increasingly high-resolution first image data and higher speeds of the material web (i.e., a requirement for more images per second) in the longitudinal direction, large amounts of data are generated, which should be transmitted to a first computing unit for observation and/or inspection in real time if possible. This results in high transmission rates of image data.

Frequently (but not necessarily), the device for observation and/or inspection comprises at least one second camera unit which captures second image data of the material web, for example at different positions of the device for processing the material web. These large volumes of data should also be transferred to the first computing unit in real time as far as possible. If at least the first and second image data are to be processed on the first computing unit in real time—i.e., almost simultaneously—the first computing unit would have to be designed with the appropriate performance. For example, the first computing unit would have to include suitable graphics processing power that is designed to process at least the first and second image data at a high transmission rate. However, such a first computing unit could not currently be realized as an efficient and inexpensive embedded (i.e., task-specific) computing unit, in particular because the waste heat from a graphics card, for example, would be too great and/or fans would have to be installed. Instead, for example, a desktop computing unit would be required, which is more expensive than two embedded computing units, each designed to process the first and second image data, respectively. In addition, two embedded computing units are also more resource-efficient than one desktop computing unit.

However, a desktop computing unit also proves to be disadvantageous insofar as devices for observing and/or inspecting a material web are to be offered as a function of customer requirements and, in particular, on a modular basis. In particular, as many identical parts as possible should be used for different versions of the device for monitoring and/or inspecting the material web (according to customer requirements). In addition to cost savings, this also enables retrofitting. If, for example, a device for observing and/or inspecting a material web is to comprise only exactly the first camera unit, a non-embedded computing unit—e.g. a desktop computing unit with, for example, a large graphics card, fan(s), etc.—would be oversized for processing only the first image data from the first camera unit and, in particular, would be associated with unnecessarily high power consumption (and, a fortiori, too expensive, see above). If, on the other hand, an embedded computing unit were offered for this application with only exactly the first camera unit and a large non-embedded computing unit for other applications with at least the first and second camera units, this would not correspond to the desired modularity, as the devices, in particular their software, would have to be designed differently depending on whether they comprise one or more camera units. Additional devices to be designed separately, in particular their software, would arise if the customer subsequently requested a second camera unit. This retrofitting option should also be available.

According to the disclosed subject matter, therefore, in the light of the requirements discussed, a (preferably embedded) computing unit is used for processing the respective image data for both the first and the second camera unit.

In this case, in order to be able to analyze at least the first and second image data simultaneously on a computing unit (here: the second computing unit) for the purpose of observing and/or inspecting the material web, it is desirable, and therefore necessary, to be able to transmit the first image data from the first computing unit to a second computing unit, preferably in real time.

As known in the prior art, the first computing unit may be connected to the second computing unit (at least) for image data transmission via Ethernet controllers and an Ethernet cable. However, with regard to the already discussed applications of image data transmission with increasingly high transmission rates, Ethernet controllers and Ethernet cables for up to 1 Gbit/s are no longer sufficient. In fact, the transfer rate of 120 MB/s, which results for 20 RGB megapixel images—each with a size of 60 MB—at a frame rate of e.g., 2 Hz, already exceeds the real maximum achievable transfer rate of around 112 MB/s with a 1 Gbit/s Ethernet controller and Ethernet cable (e.g. due to the overhead in the Ethernet frames). Faster Ethernet controllers and Ethernet cables for up to 10 Gbit/s, for example, are available but are (currently) too expensive. In addition, even higher resolutions (30 RGB megapixel images—each with a size of 90 MB) and higher frame rates (e.g., 15 or 16 Hz) are desirable, for which even 10 Gbit/s Ethernet controllers and Ethernet cables would no longer be sufficient. For the same reason, 2.5 or 5 Gbit/s Ethernet controllers and Ethernet cables are not an option here. Ethernet controllers and Ethernet cables with transmission rates of over 10 Gbit/s would be possible, but are currently too expensive.

It can therefore be regarded as a task of the disclosed subject matter—apart from the division of a computing unit into a first and a second computing unit—to specify an alternative, in particular a more cost-effective device (compared to, for example, 10 Gbit/s Ethernet controllers and Ethernet cables) for observing and/or inspecting a material web, in which image data can be transmitted from the first computing unit to the second computing unit at sufficiently high transmission rates. For example, this object of the disclosed subject matter is achieved by a device according to a first general aspect for observing and/or inspecting a web of material. The device comprises a first camera unit for capturing first image data of the material web. The device further comprises a first computing unit connected to the first camera unit via a first camera connection line, wherein the first computing unit is adapted to receive and, optionally, process the first image data. The device further comprises a second computing unit configured to receive and, optionally, process the first image data from the first computing unit. The first computing unit and the second computing unit are connected via a first USB line. The first image data can be transferred to the second computing unit via the first USB line.

The device according to the first general aspect may comprise an interface connected to the second computing unit and adapted to receive and output the first image data from the second computing unit. Such an interface makes it possible to intervene (manually) in the process of processing the material web if necessary. This can ensure, for example, that the specified quality criteria are met and/or that waste is reduced.

Further embodiments are defined in the dependent claims.

Disclosed further is an apparatus according to a second general aspect for processing a web of material. The device includes the material web. The device further comprising the device for observing and/or inspecting the web of material according to the first general aspect (or an embodiment thereof).

The device according to the first general aspect (or an embodiment thereof) comprises two computing units, wherein data, in particular image data, can be transmitted from the first computing unit to a second computing unit via a USB line.

As discussed above, the use of two computing units with data transmission instead of one computing unit is advantageous for reasons of, for example, efficiency, modularity, and/or cost, especially when efficient and inexpensive embedded (i.e., e.g., task-specific) computing units are provided as first and second computing units. Further, for example, in embodiments in which the second computing unit is connected to the interface, the first computing unit (e.g., near the first camera unit) may be arranged at a different location on the material web than the second computing unit (e.g., near the interface and/or near a second camera unit). On the other hand, the first and second computing units do not have to be arranged far apart and can also be arranged next to one another or close to one another. Alternatively, in the latter case, the first computing unit and the second computing unit could also be realized by a computing unit, in particular by a non-embedded desktop computing unit, which would usually be placed in a control cabinet. It is true that such a computing unit would eliminate the need for data transmission between the first and second computing units. However, such a desktop computing unit is out of the question here for the reasons already discussed, e.g., efficiency, modularity, and/or costs.

Conventionally, the two computing units could be connected via their Ethernet controller and Ethernet cable (e.g., to an Ethernet switch). For sufficiently fast data transmission of large image data, the Ethernet controllers and the Ethernet cable must be designed for at least 2.5 Gbit/s, sometimes even 10 Gbit/s. However, such hardware is (currently) too expensive. By providing transmission via USB interfaces and a USB line instead of via an Ethernet controller and an Ethernet cable, the device according to the first general aspect (or an embodiment thereof) avoids these high costs.

The devices according to the first and second general aspects are based on the realization that the first USB line between the first and second computing units can be used for sufficiently fast data transmission. This is particularly advantageous because, even if the first and second computing units are designed as embedded computing units, they already have suitable USB interfaces (e.g., USB 3.0 or higher specified) and no additional costs are incurred in this respect.

Particularly advantageous are embodiments in which the USB interfaces are integrated into a network, in particular an Ethernet. A virtual network apparatus whose maximum burst adjustment has been increased can be used. This means that more data can be transmitted simultaneously and the transmission rate (according to the desired application) can be increased. Furthermore, virtual network interfaces can advantageously be used in the first and second computing units, whose respective maximum transmission units (MTU) are increased. This can also increase the transmission rate (according to the desired application). This makes frame rates of 15 Hz possible, for example, for which even 1 Gbit/s Ethernet controllers and Ethernet cables would no longer be sufficient.

For example, thanks to the image transfer rates achievable by the proposed devices according to the first or second general aspect (or embodiments thereof), a printing process can be supported from the set-up phase to the completion of the job by continuously displaying the printed web in the highest resolution and image quality. The areas of the print that are decisive for quality, such as register and color marks or distinctive color areas, are permanently available to the printer in the highest resolution and thus safeguard the production process. This allows the production speed to be increased while at least maintaining the quality of the print. Waste can also be reduced. Various embodiments of the devices can be realized particularly advantageously using identical parts. The disclosed subject matter makes it possible to build parts of devices for observing and/or inspecting a material web in exactly the same configuration. This also makes it possible to retrofit a second camera unit at a later date, for example. The common parts also make storage and maintenance easier. Furthermore, there is no additional work involved in maintaining the operating system and software.

Thanks to the devices according to the disclosed subject matter, it is also achieved that in the event that the subset of multi-camera units only accounts for a smaller proportion of the total number of devices sold for observing and/or inspecting a material web, the costs for individual devices for observing and/or inspecting a material web without multi-camera units are not increased.

In the case of a device for observing and/or inspecting a material web without multi-camera units, a USB interface used for connecting a computing unit to another computing unit can be used for other functions such as peripheral apparatuses. The solution is also very well suited for connection to a customer computing unit. There is also a Windows driver that enables use with customer computing units with USB interfaces 3.0 or higher. This eliminates the requirement for 10 Gbit/s

Ethernet controllers or a 10 Gbit/s network card for customer computing units. In the vast majority of cases, a 10 Gbit/s connection is not available, but a USB 3.0 or higher connection is.

The proposed devices according to the first or second general aspect (or embodiments thereof) are efficient, cost effective and resource saving.

### BRIEF DESCRIPTION OF THE FIGURES

FIG. 1 shows schematically an exemplary device for observing and/or inspecting a material web comprising a first camera unit, a first computing unit and a second computing unit.

FIG. 2 shows schematically an exemplary device for processing a material web, in particular an exemplary device for observing and/or inspecting the material web comprising a first camera unit, a first computing unit, a second computing unit and an interface.

FIG. 3 shows schematically an exemplary device for processing a material web, in particular an exemplary device for observing and/or inspecting the material web comprising a first camera unit, a second camera unit, a first computing unit, a second computing unit and an interface.

FIG. 4 shows schematically an exemplary device for processing a material web, in particular an exemplary device for observing and/or inspecting the material web comprising a first camera unit, a second camera unit, a first computing unit, a second computing unit, a third computing unit and an interface.

### DETAILED DESCRIPTION

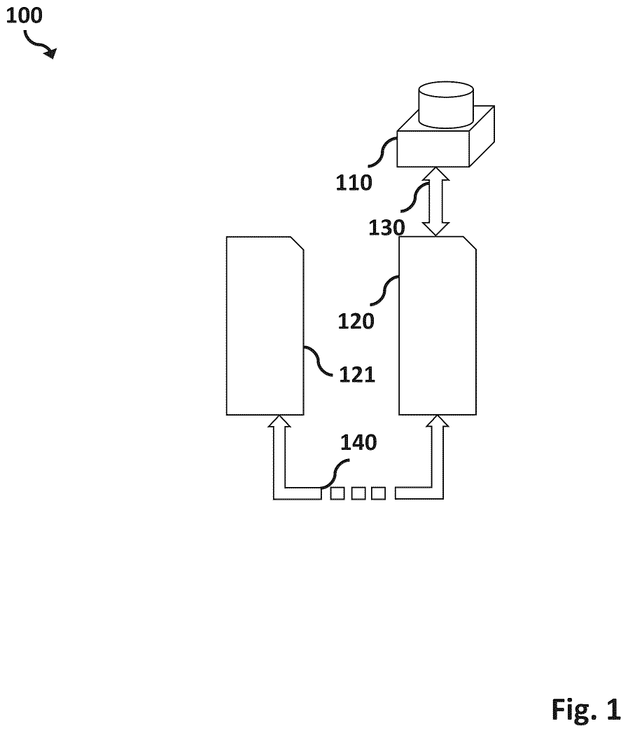

Disclosed first is a device 100 for observing and/or inspecting a web of material (shown in a later figures), which is exemplarily and schematically illustrated in FIG. 1. The device 100 comprises a first camera unit 110 for capturing first image data of the material web. A camera unit may comprise one or more image sensors and optionally one or more lighting apparatuses for the receptacle of an image. The first camera unit 110 may, for example, comprise one or more cameras, in particular digital cameras. For example, the first camera unit 110 may comprise a telephoto and/or wide-angle camera. The first image data can comprise an image of the material web, in particular of one side of the material web. In other words, the first image data may be generated from a receptacle of a surface of the material web. Furthermore, the first image data can be generated by taking further receptacles of the surface of the material web, for example at a predetermined frame rate. The first image data can comprise images with a frame rate of at least 2 Hz, preferably at least 5 Hz, particularly preferably at least 15 Hz. For example, the frame rate can be 15 or 16 Hz. An image can comprise at least 8 megapixels or at least 8 RGB megapixels. Preferably, an image can comprise at least 14 megapixels or at least 14 RGB megapixels. Particularly preferably, an image can comprise at least 20 megapixels or at least 20 RGB megapixels.

The device 100 further comprises a first computing unit 120 connected to the first camera unit 110 via a first camera connection line 130 and adapted to receive the first image data. The first computing unit 120 may further be configured to process the first image data. The first camera connection line 130 can also be a USB line, for example. A computing unit can, for example, include a central processor, a working memory, and data memory for the electronic processing of data and USB interfaces. The first computing unit 120 is preferably an embedded (i.e., e.g., task-specific) computing unit. Compared to a desktop computing unit, for example, such an embedded computing unit is more efficient, more resource-friendly and cheaper.

The apparatus 100 further comprises a second computing unit 121 configured to receive the first image data from the first computing unit 120, wherein if the first image data is processed by the first computing unit 120, the first image data processed by the first computing unit 120 may be received. The second computing unit 121 may further be configured to (further) process the first image data (processed) by the first computing unit 120. Preferably, the second computing unit 121 is also an embedded (i.e., e.g., task-specific) computing unit. Compared to a desktop computing unit, for example, such an embedded computing unit is more efficient, more resource-friendly and cheaper. Embedded first and second computing units 120, 121 are also more efficient, resource efficient and less expensive than a single desktop computing unit. The second computing unit 121 may be a customer computing unit. A customer computing unit can be used, for example, if the customer only wants the image data to be made available and then wants to display it on its own customer interface via its own customer computing unit. Operation of, for example, the first camera unit 110 can then also be performed via the customer computing unit.

The first computing unit 120 and the second computing unit 121 are connected via a first USB line 140 (and optionally via further connecting elements). The first image data is transmitted to the second computing unit 121 via the first USB line 140, wherein if the first image data is processed by the first computing unit 120, the first image data processed by the first computing unit may be transmitted via the first USB line 140.

The device 100 is primarily intended for the transmission of image data. Alternatively, or additionally, (any) data, i.e., not necessarily exclusively first image data, can be transmitted via the first USB line 140. Non-image data may include, for example, control information and/or operating parameters of the first camera unit 110. Furthermore, the first USB line 140 can also be used to transmit (any) data from the second computing unit 121 to the first computing unit 120. This data may include, for example, control information to the first camera unit 110, in particular from an interface 150.

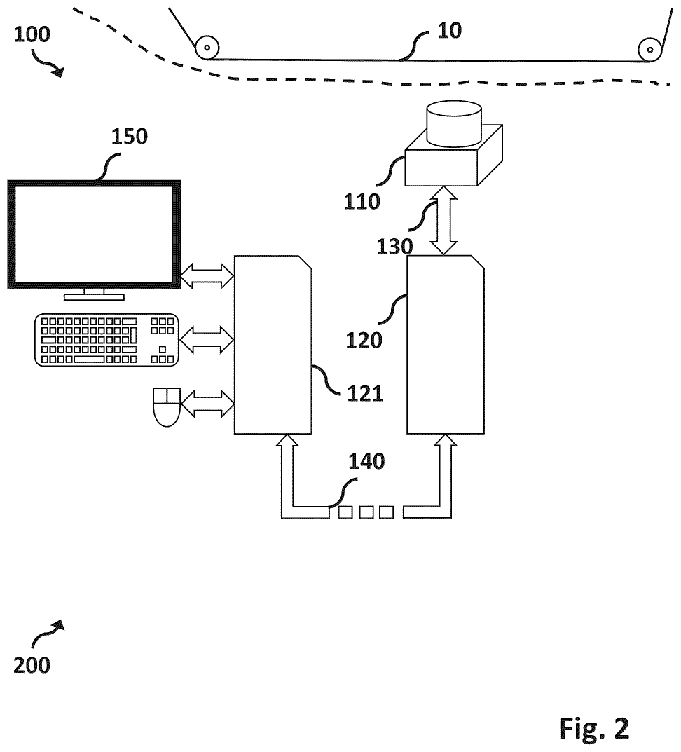

The device 100 may comprise, as exemplarily and schematically illustrated in FIGS. 2-4, an interface 150 connected to the second computing unit 121. The interface 150 may be configured to receive the first image data from the second computing unit 121. The interface 150 can also be designed to output the received first image data, for example to a process monitor. In the case where the first image data is processed by the first and/or second computing unit, the first image data processed by the first and/or second computing unit may be received by the interface 150 and, optionally, output.

The interface 150 may include an output apparatus such as a display screen. Alternatively, or additionally, the interface 150 may comprise an input apparatus such as a keyboard and/or a mouse. As shown in FIG. 2-4, the interface 150 may comprise a screen as well as a keyboard and a mouse.

Alternatively, the input apparatus and the output apparatus can be integrated in one apparatus. For example, the input apparatus and the output apparatus can be integrated in a touch screen. The input apparatus can be used to output the first and/or second image data to the interface 150, for example at different zoom levels.

Each of the computing units used in the devices 100 and 200 may include a respective interface that may be used to maintain and/or commission the respective computing units.

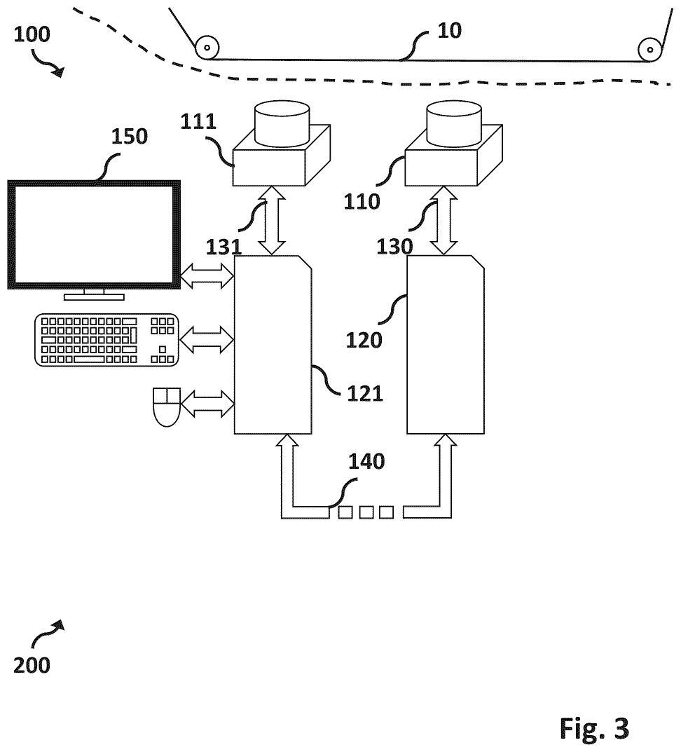

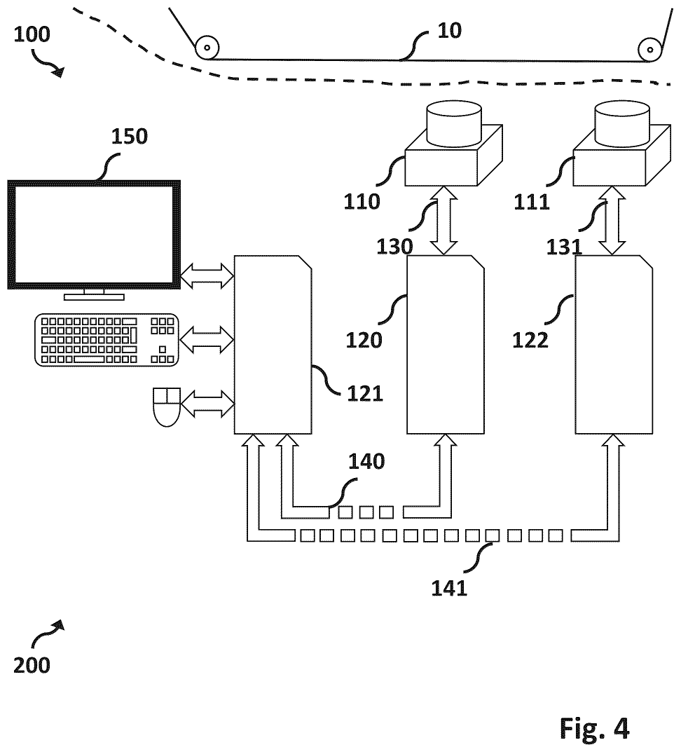

The device 100 may comprise, as exemplarily and schematically shown in FIGS. 3-4, a second camera unit 111 for capturing second image data of the material web 10. A camera unit may comprise one or more image sensors and optionally one or more lighting apparatuses for the receptacle of an image. The second camera unit 111 may, for example, comprise one or more cameras, in particular digital cameras. For example, the second camera unit 111 may comprise a telephoto and/or wide-angle camera. The second image data may comprise an image of the material web 10, in particular of one side (the same or the other side) of the material web 10. In other words, the second image data may be generated from a receptacle of a surface of the material web 10. Furthermore, the second image data can be generated by taking further receptacles of the surface of the material web 10, for example at a predetermined frame rate. The second image data can comprise images with a frame rate of at least 2 Hz, preferably at least 5 Hz, particularly preferably at least 15 Hz. For example, the frame rate can be 15 or 16 Hz. An image can comprise at least 8 megapixels or at least 8 RGB megapixels. Preferably, an image can comprise at least 14 megapixels or at least 14 RGB megapixels. Particularly preferably, an image can comprise at least 20 megapixels or at least 20 RGB megapixels.

Thanks to at least two camera units with sufficiently high resolution, it is possible to capture sophisticated image data during the processing of the material web 10. For example, they enable print images to be displayed on moving webs with the highest level of detail and/or color fidelity. The camera units can be moved manually or motorized in order to approach positions above the material web 10 with maximum precision in order to display the corresponding images on the interface 150, for example. Depending on the zoom level, a telephoto or wide-angle camera of a camera unit 110, 111 can be activated. While zooming, you can then switch imperceptibly between the telephoto camera and the wide-angle camera. Print images can thus be displayed with a multiple of their resolution. This enables (almost) instantaneous zooming up to the highest resolution.

As shown schematically in FIG. 3, the second computing unit 121 may be connected to the second camera unit 111 via a second camera connection line 131. The second computing unit 121 may be configured to receive the second image data. The second computing unit 121 may further be configured to process the second image data. The second camera connection line 131 can also be a USB line, for example.

Alternatively, as shown schematically in FIG. 4, the device 100 may include a third computing unit 122 connected to the second camera unit 111 via a second camera connection line 131 and configured to receive the second image data. The third computing unit 122 may further be configured to process the second image data. Preferably, the third computing unit 122 is also an embedded (i.e., e.g., task-specific) computing unit. The second camera connection line 131 can also be a USB line, for example. The second computing unit 121 and the third computing unit 122 may be connected via a second USB line 141. The second image data can then be transmitted to the second computing unit 121 via the second USB line 141. Sufficiently fast data transmission via the second USB line 141 can (but does not have to) be realized in the same manner as data transmission via the first USB line 140 (e.g., with maximum burst adjustment of the virtual network device equal to 15 and changing the MTU of the virtual network interfaces to 15300, see below). In addition, as with the first USB line 140, non-image data can also be transmitted via the second USB line 141 in both directions if required.

The interface 150 may be designed to (also) receive the second image data from the second computing unit. The interface 150 can furthermore (also) be designed to output the received second image data, for example to a process monitor. In the case where the second image data is processed by the second or third computing unit 121, the second image data processed by the second or third computing unit may be received by the interface 150 and, optionally, output.

The frame rate of the first image data and the second image data may or may not be the same. For example, the first and second image data can be output (almost) synchronously on the interface 150. For example, the first image data can be recorded from one side of the material web 10 and the second image data can be recorded from the other side of the material web 10. Alternatively, in another example, the first and second image data may be recorded from the same side of the material web 10. In each of these cases, the first and second image data can be recorded offset or at the same position (e.g., in the longitudinal direction of the material web).

Thanks to the second camera unit 111, which is connected either via the second camera connection line 131 to the second computing unit 121 or via the second camera connection line 131 and the second USB line 141 to the second computing unit 121, the first and second image data can be monitored in (near) real time at the second computing unit 121, i.e. at a single computing unit and in particular via the interface 150 connected to the second computing unit 121. This can improve the observation and/or inspection of the material web 10. Another advantage is that in all embodiments of the device 100, the second camera unit 111 and, if necessary, the third computing unit 122 can be retrofitted.

Via the input apparatus of the interface 150, the first camera unit 110 and the second camera unit 111 and possibly further camera units can be controlled independently of one another in an operating mode. In another operating mode, the first camera unit 110 and the second camera unit 111 and possibly other camera units can be controlled in a coupled manner via the input apparatus of the interface 150, for example in a lead/follow mode. For example, the first camera unit 110 can be used for register control and/or color monitoring and the second camera unit 111 for independent work. Alternatively, or additionally (e.g., at another time), the first camera unit 110 and the second camera unit 111 can be used to monitor successive processes. Alternatively, or additionally (e.g., at another time), the first camera unit 110 and the second camera unit 111 may be used to monitor the left and right web edges of the material web 10 (with respect to parallelism). Alternatively, or additionally (e.g., at another time), the first camera unit 110 and the second camera unit 111 can be used for checking front and back register (e.g., via grid lines). Alternatively, or additionally (e.g., at another time), the first camera unit 110 and the second camera unit 111 can be used for a combination of white light and UV light.

The first computing unit 120 may comprise a first USB interface and the second computing unit 121 may comprise a second USB interface, wherein the first USB interface and the second USB interface may be connected via the first USB line 140. In this case, the first computing unit 120 and the second computing unit 121 may be directly connected via the first USB line 140, such as in FIG. 1-4. In other words, the data transmission can be realized via a point-to-point connection between the first and the second computing unit.

The third computing unit 122, if present, may comprise a third USB interface, wherein the third USB interface and the second USB interface (or the third USB interface and a fourth USB interface of the second computing unit 121) may be connected via the second USB line 141. In this case, the second computing unit 121 and the third computing unit 122 may be connected directly via the second USB line 141, as for example in FIG. 4. In other words, data transmission can be realized via a point-to-point connection between the second and third computing units.

A USB interface can be a physical connection option (e.g., a socket) for a USB line 140, 141. A USB line 140, 141 can be a cable for connecting two USB interfaces.

One computing unit 120, 121 can be operated in host mode and one in device mode. For example, the first computing unit 120 may be operated in device mode and the second computing unit 121 may be operated in host mode. For such a connection, the computing units must each be equipped with a USB-C port, for example. The USB-C port must support switching between host/device mode using the USB OTG specification. The special circuitry enables the computing units 120, 121 to detect whether the voltage Vdd is present on the first USB line 140. The host or device mode can be switched dynamically. With respect to the second USB line 141, if present, for example, the third computing unit 122 may be operated in device mode and the second computing unit 121 may be operated in host mode.

The first USB interface and the second USB interface can be integrated into a network, wherein the network can preferably be an Ethernet.

For this purpose, the first USB interface can be integrated into the network via a virtual network apparatus The third USB interface can also be integrated into the or another network via a (further) virtual network apparatus. A network apparatus can be a peripheral that can be used in a computing unit to establish a network connection. The network apparatus can be virtual in the sense that the network apparatus does not exist physically, but only in the working memory of one or more computing units, i.e., it is simulated. This means that a USB interface can be used in a network, especially in an Ethernet. The virtual network apparatus can be based on the Linux driver g_ether of the Linux-USB Gadget API Framework. In other words, using the Linux driver g_ether, the virtual network apparatus can be generated. The use of the Linux driver g_ether proves to be advantageous, as the maximum burst adjustment can be selected for the virtual network apparatus. The maximum burst adjustment of the virtual network apparatus can be greater than 0. Preferably, the maximum burst adjustment of the virtual network apparatus may be greater than or equal to 10. Particularly preferably, the maximum burst adjustment of the virtual network apparatus can be equal to 15. The greater the maximum burst adjustment of the virtual network apparatus, the more data can be sent simultaneously. This has the advantage of increasing the transmission rate. A maximum burst adjustment of 15 thus enables the fastest possible transmission rate.

The network may be configured by the first computing unit 120 via a first virtual network interface. A network interface can comprise a software interface belonging to a piece of hardware for configuring a network connection. The network interface can be virtual in the sense that the hardware associated with the software interface (in this case the network apparatus) does not exist physically, but only virtually.

The maximum transmission unit (MTU) of the first virtual network interface can be configured (i.e., selected) to be greater than 1500. Preferably, the maximum transmission unit (MTU) of the first virtual network interface can be configured to be greater than 7000. Particularly preferably, the maximum transmission unit (MTU) of the first virtual network interface can be configured equal to 15300. The number of maximum transmission units (e.g., 1500, 7000, 15300, or the like) may be configured in a virtual network interface and internally interpreted in terms of bytes.

The network may be configured by the second computing unit 121 via a second virtual network interface. The virtual network apparatus can, for example, be integrated as a second virtual network interface when running a Linux distribution on the second computing unit 121 using the Linux driver cdc_ether of the Linux CDC Ethernet Support. Alternatively, the virtual network apparatus can be integrated as a second virtual network interface, e.g., when running a Windows operating system on the second computing unit 121 using the Windows RNDIS (gadget) driver.

The maximum transmission unit (MTU) of the second virtual network interface can be configured (i.e., selected) to be greater than 1500. Preferably, the maximum transmission unit (MTU) of the second virtual network interface can be configured to be greater than 7000. Particularly preferably, the maximum transmission unit (MTU) of the second virtual network interface can be configured equal to 15300.

The larger the maximum transmission units (MTU) of the first and second virtual network interface is selected, the more data can be transmitted within a transmission unit. This also has the advantage of increasing the transmission rate. It can be advantageous to configure the maximum transmission units (MTU) of the first and second virtual network interface identically so that transmission units do not have to be split or merged.

In an embodiment of the device 100, the maximum burst adjustment of the virtual network apparatus may be equal to 15 and the maximum transmission units (MTU) of the first and second virtual network interfaces may be equal to 15300. As soon as the connection between two computing units (e.g., between the first computing unit 120 and the second computing unit 121) is established, the Windows RNDIS (gadget) driver, for example, can be activated on the host. This driver makes it possible to establish a virtual network connection. By modifying the maximum burst adjustment in the driver itself from 0 to e.g., 15 and changing the MTU of the virtual network interfaces to 15300, for example, the transfer rate can be increased to approx. 2.6 Gbit/s compared to approx. 25 Mbit/s without modification on USB 2.

In fact, the disclosed subject matter was tested using two embedded computing units. An embedded computing unit was operated as a device due to the existing USB 3 USB-C OTG port. The modifications described above (maximum burst adjustment of the virtual network apparatus equal to 15, change of the MTU of the virtual network interfaces to 15300) were carried out on this. The measured transfer rate was approx. 3.2 Gbit/s. Two programs were also used to establish a TCP connection that transmits simulated image data. In such a scenario, which was modeled on the real application, a transfer rate of approx. 2.6 Gbit/s was achieved, which corresponds to around 325 MB/s. This means, for example, that initial image data with 20 RGB megapixels (60 MB per image) and a frame rate of 5 Hz can already be transferred from the first computing unit 120 to the second computing unit 121 (required transfer rate of 300 MB/s). Alternatively, for example, initial image data with 6.6 RGB megapixels (20 MB per image) and a frame rate of 15 Hz could be transferred from the first computing unit 120 to the second computing unit 121 (required transfer rate of 300 MB/s).

The first USB line 140, the first camera connection line 130 and/or the second camera connection line 131 may have (in total) a length of at least 10 m, at least 50 m, or at least 100 m. Alternatively or additionally, the second USB line 141, the first camera connection line 130 and/or the second camera connection line 131 may (in total) have a length of at least 10 m, of at least 50 m, or of at least 100 m.

For example, the first USB line 140 may have a length of at least 2 cm, at least 10 m, at least 50 m, or at least 100 m. Alternatively or additionally, the first camera connection line 130 may have a length of at least 2 cm, of at least 10 m, of at least 50 m, or of at least 100 m, for example. Alternatively, or additionally, the second camera connection line 131, if present, may have a length of at least 2 cm, of at least 10 m, of at least 50 m, or of at least 100 m, for example. For example, the first computing unit 120 and the second computing unit 121 may be adjacent to each other so that the first USB line 140 need only have a short length. The shortest length of the first USB line 140 results from the sum of two USB plugs and is 2 cm, for example. Thanks to the possible different lengths, the first computing unit 120, the second computing unit 121, the first camera unit 110 and, if necessary, the second camera unit 111 can be arranged at different positions on the material web 10, depending on the customer's wishes and/or requirements.

The second USB line 141, if present, may also have a length of at least 2 cm, of at least 10 m, of at least 50 m, or of at least 100 m, for example. Alternatively, or additionally, the second camera connection line 131, if present, may have a length of at least 2 cm, of at least 10 m, of at least 50 m, or of at least 100 m, for example. For example, the second computing unit 121 and the third computing unit 122 may be adjacent to each other, so that the second USB line 141 has only a short length. The shortest length of the second USB line 141 also results from the sum of two USB plugs and is e.g. 2 cm. Thanks to the possible different lengths, the second computing unit 121, the third computing unit 122 and the second camera unit 111 can be arranged at different positions on the material web 10 depending on the customer's wishes and/or requirements, if any.

The different lengths provide maximum flexibility when observing and/or inspecting the material web 10.

The first USB line 140, i.e., the transmission technology, can be specified according to the USB 3.0 standard or higher. For example, the first USB line 140 can be specified according to one of the USB 3.0, USB 3.1, or USB 3.2 standards. If available, the second USB line 141, i.e., the transmission technology, can also be specified according to the USB 3.0 standard or higher. For example, the second USB line 141 can be specified according to one of the USB 3.0, USB 3.1, or USB 3.2 standards. The higher the specification, the higher the transfer rates.

The first USB line 140 may comprise a copper conductor. This is particularly advantageous in cases where the first computing unit 120 and the second 121 computing unit are connected via a short first USB line 140, because a more expensive optical fiber can be avoided here without sacrificing transmission rate. Alternatively, the first USB line 140 can comprise an optical waveguide, in particular an optical fiber inner conductor. Despite the higher costs, a fiber optic cable can be advantageous compared to a copper cable if the first USB line 140 is longer and the desired transmission rate can only be achieved using the fiber optic cable.

The second USB line 141 can comprise a copper conductor. This is particularly advantageous in cases where the second computing unit 121 and the third 122 computing unit are connected via a short second USB line 141, because a more expensive optical fiber can be avoided here without sacrificing transmission rate. Alternatively, the second USB line 141 can comprise an optical waveguide, in particular an optical fiber inner conductor. Despite the higher costs, a fiber optic cable can be advantageous compared to a copper cable if the second USB line 141 is longer and the desired transmission rate can only be achieved using the fiber optic cable.

Both fiber optic and copper conductors can be specified according to USB 3.0 or higher.

The second or fourth USB interface and the third USB interface can be integrated into another network, preferably another Ethernet. The third USB interface can be integrated into the wider network via a third virtual network apparatus. The further network may be configured by the third computing unit 122 via a third virtual network interface. The second or fourth USB interface can be integrated into the wider network via a fourth virtual network apparatus. The further network can be configured by the second computing unit 121 via a fourth virtual network interface.

Further disclosed is a device 200 for processing a material web 10, schematically illustrated in FIGS. 2-4. The device 200 comprises the material web 10 and any embodiment of the device 100 disclosed herein for observing and/or inspecting the material web 10. The device 200 usually comprises further elements such as one or more web guiding systems comprising drive, control, and rollers for moving the material web 10 in the longitudinal direction. For example, the device 200 also comprises at least one processing device—for example, at least one pressure roller, at least one pressure head and/or a web cutting system—for processing the material web 10.

Alternatively, or additionally, the disclosed subject matter may also be defined according to the following incarnations:
Incarnation 1. A device (100) for observing and/or inspecting a material web (10), comprising:
a first camera unit (110) for capturing first image data of the material web (10);
a first computing unit (120), connected to the first camera unit via a first camera connection line (130), adapted to receive and, optionally, process the first image data;
a second computing unit (121), adapted to receive the first image data from the first computing unit (120), and, optionally, to process it;
wherein the first computing unit (120) and the second computing unit (121) are connected via a first USB line (140);
wherein the first image data is transmitted to the second computing unit (121) via the first USB line (140).
Incarnation 2. The device (100) according to incarnation 1, comprising:
an interface (150) connected to the second computing unit (121) and adapted to receive and output the first image data from the second computing unit (121).
Incarnation 3. The device (100) according to any of the preceding incarnations, comprising: a second camera unit (111) for capturing second image data of the material web (10).
Incarnation 4. The device (100) according to incarnation 3, wherein the second computing unit (121) is connected to the second camera unit (111) via a second camera connection line (131) and is adapted to receive and, optionally, process the second image data.
Incarnation 5. The device (100) according to incarnation 3, comprising:
a third computing unit (122), connected to the second camera unit (111) via a second camera connection line (131), is adapted to receive and, optionally, process the second image data.
Incarnation 6. The device (100) according to incarnation 5, wherein the second computing unit (121) and the third computing unit (122) are connected via a second USB line (141);
wherein the second image data is transmitted to the second computing unit (121) via the second USB line (141).
Incarnation 7. The device (100) according to any of the preceding incarnations when dependent on incarnations 2 and 3, wherein the interface (150) is adapted to receive and output the second image data from the second computing unit (121).
Incarnation 8. The device (100) according to any of the preceding incarnations, wherein the first computing unit (120) comprises a first USB interface and the second computing unit (121) comprises a second USB interface, wherein the first USB interface and the second USB interface are connected via the first USB line (140).
Incarnation 9. The device (100) according to incarnation 8, if dependent on incarnation 6, wherein the third computing unit (122) comprises a third USB interface,
wherein the third USB interface and the second USB interface are connected via the second USB line (141); or
wherein the second computing unit (121) comprises a fourth USB interface and the third USB interface and the fourth USB interface are connected via the second USB line (141).
Incarnation 10. The device (100) according to incarnation 8 or 9, wherein the first USB interface and the second USB interface are integrated into a network, preferably into an Ethernet.
Incarnation 11. The device (100) according to incarnation 10, wherein the first USB interface is integrated into the network via a virtual network apparatus.
Incarnation 12. The device (100) according to incarnation 11, wherein the virtual network apparatus is based on the Linux driver g_ether of the Linux USB gadget API framework.
Incarnation 13. The device (100) according to incarnation 11 or 12, wherein the maximum burst adjustment of the virtual network apparatus is greater than 0, preferably greater than or equal to 10, particularly preferably equal to 15.
Incarnation 14. The device (100) according to any of incarnations 10 to 13, wherein the network can be configured by the first computing unit (120) via a first virtual network interface.
Incarnation 15. The device (100) according to incarnation 14, wherein the maximum transmission unit (MTU) of the first virtual network interface is configured to be greater than 1500, preferably greater than 7000, particularly preferably 15300.
Incarnation 16. The device (100) according to any of incarnations 8 to 15, wherein the network can be configured by the second computing unit (121) via a second virtual network interface.
Incarnation 17. The device (100) according to incarnation 16, if dependent on incarnation 11, wherein the virtual network apparatus is integrated by the Linux driver cdc_ether of the Linux CDC Ethernet Support as a second virtual network interface.
Incarnation 18. The device (100) according to incarnation 16, if dependent on incarnation 11, wherein the virtual network apparatus is integrated by the Windows RNDIS driver as a second virtual network interface.
Incarnation 19. The device (100) according to any of incarnations 16 to 18, wherein the maximum transmission unit (MTU) of the second virtual network interface is configured greater than 1500, preferably greater than 7000, particularly preferably 15300.
Incarnation 20. The device (100) according to any of the preceding incarnations, wherein the first USB line (140) or, if dependent on incarnation 6, the second USB line (141), the first camera connection line (130) and/or, if dependent on incarnation 4 or 5, the second camera connection line (131) has a length of at least 10 m, of at least 50 m, or of at least 100 m.
Incarnation 21. The device (100) according to any of the preceding incarnations, wherein the first USB line (140) is specified according to the standard USB 3.0 or higher, in particular wherein the first USB line (140) is specified according to one of the standards USB 3.0, USB 3.1 or USB 3.2.
Incarnation 22. The device (100) according to any of the preceding incarnations, wherein the first USB line (140) comprises a copper conductor.
Incarnation 23. The device (100) according to any of the preceding incarnations, wherein the first USB line (140) comprises an optical waveguide, in particular an optical fiber inner conductor.
Incarnation 24. The device (100) according to any of the preceding incarnations, if dependent on incarnation 6, wherein the second USB line (141) comprises a copper conductor.
Incarnation 25. The device (100) according to any of the preceding incarnations, if dependent on incarnation 6, wherein the second USB line (141) comprises an optical waveguide, in particular an optical fiber inner conductor.
Incarnation 26. The device (100) according to any of the preceding incarnations, wherein the first image data and/or, if dependent on incarnation 3, the second image data comprise images with a frame rate of at least 2 Hz, preferably of at least 5 Hz, particularly preferably of at least 15 Hz.
Incarnation 27. The device (100) according to incarnation 26, wherein an image comprises at least 8 megapixels or at least 8 RGB megapixels, preferably at least 14 megapixels or at least 14 RGB megapixels, particularly preferably at least 20 megapixels or at least 20 RGB megapixels.
Incarnation 28. The device (100) according to any of the preceding incarnations, if dependent on incarnation 7, wherein the first and second image data are output synchronously on the interface (150).
Incarnation 29. The device (100) according to any of the preceding incarnations, if dependent on incarnation 3, wherein the first image data is recorded from one side of the material web (10) and the second image data is recorded from the other side of the material web (10).
Incarnation 30. The device (100) according to any of the preceding incarnations, if dependent on incarnation 3, wherein the first and second image data are recorded from the same side of the material web (10).
Incarnation 31. The device (100) according to any of the preceding incarnations, if dependent on incarnation 2, wherein the interface (150) comprises an input apparatus and/or an output apparatus, in particular a screen.
Incarnation 32. The device (100) according to any of the preceding incarnations, if dependent on incarnations 8 and 9, wherein the second or fourth USB interface and the third USB interface are integrated into a further network, preferably into a further Ethernet.
Incarnation 33. The device (100) according to incarnation 32, wherein the third USB interface is integrated into the further network via a third virtual network apparatus.
Incarnation 34. The device (100) according to incarnation 32 or 33, wherein the further network can be configured by the third computing unit (122) via a third virtual network interface.
Incarnation 35. The device (100) according to any of incarnations 32 to 34, wherein the second or fourth USB interface is integrated into the further network via a fourth virtual network apparatus.
Incarnation 36. The device (100) according to any of incarnations 32 to 35, wherein the further network can be configured by the second computing unit (121) via a fourth virtual network interface.
Incarnation 37. The device (100) according to any of the preceding incarnations, if dependent on incarnation 6, wherein the second USB line (141) is specified according to the standard USB 3.0 or higher, in particular wherein the second USB line (141) is specified according to one of the standards USB 3.0, USB 3.1 or USB 3.2.
Incarnation 38. The device (200) for processing a material web (10), comprising:
the material web (10);
the device (100) for observing and/or inspecting the material web (10) according to any of the preceding incarnations.

1. A device for observing and/or inspecting a material web, comprising:
a first camera unit for capturing first image data of the material web;
a first computing unit, which is connected to the first camera unit via a first camera connection line, is adapted to receive the first image data; and
a second computing unit adapted to receive the first image data from the first computing unit;
wherein the first computing unit and the second computing unit are connected via a first USB line;
wherein the first image data is transmitted to the second computing unit via the first USB line;
wherein the first computing unit comprises a first USB interface and the second computing unit comprises a second USB interface, wherein the first USB interface and the second USB interface are connected via the first USB line;
wherein the first USB interface and the second USB interface are integrated into a network.

2. The device according to claim 1, wherein the network is an Ethernet.

3. The device according to claim 1, comprising:
a second camera unit for capturing second image data of the material web.

4. The device according to claim 1, wherein the first image data and/or, if dependent on claim 3, the second image data comprise images with a frame rate of at least 2 Hz, of at least 5 Hz or of at least 15 Hz.

5. The device according to claim 4, wherein an image comprises at least 8 megapixels or at least 8 RGB megapixels.

6. The device according to claim 4, wherein an image comprises at least 14 megapixels or at least 14 RGB megapixels.

7. The device according to claim 4, wherein an image comprises at least 20 megapixels or at least 20 RGB megapixels.

8. The device according to claim 3, wherein the second computing unit is connected to the second camera unit via a second camera connection line and is adapted to receive the second image data.

9. The device according to claim 3, comprising:
a third computing unit, which is connected to the second camera unit via a second camera connection line, is adapted to receive the second image data.

10. The device according to claim 9, wherein the second computing unit and the third computing unit are connected via a second USB line, and
the second image data is transmitted to the second computing unit via the second USB line.

11. The device according to claim 1, wherein the first USB interface is integrated into the network via a virtual network apparatus.

12. The device according to claim 11, wherein the maximum burst adjustment of the virtual network apparatus is greater than 0, greater than or equal to 10, or equal to 15.

13. The device according to claim 1, wherein the network can be configured by the first computing unit (120) via a first virtual network interface.

14. The device according to claim 13, wherein the maximum transmission unit (MTU) of the first virtual network interface is configured as greater than 1500, greater than 7000, or as 15300.

15. The device according to claim 1, wherein the network can be configured by the second computing unit via a second virtual network interface.

16. The device according to claim 15, wherein the maximum transmission unit (MTU) of the second virtual network interface is configured as greater than 1500, greater than 7000, or as 15300.

17. The device according to claim 1, wherein the first USB line is specified according to the USB 3.0 standard or higher.

18. The device according to claim 1, wherein the first USB line is specified according to one of the standards USB 3.0, USB 3.1, or USB 3.2.

19. A system for processing a material web, comprising:
the material web; and
the device for observing and/or inspecting the material web according to claim 1.
